(19) United States
(12) Patent Application Publication
(10) Pub. No.: US 2005/0230594 A1
(43) Pub. Date: Oct. 20, 2005

(54) Haptic feedback input device

(75) Inventors: Hiroyuki Sato, Tokyo (JP); Tomohiro Oikawa, Tokyo (JP); Yasuhiro Miyasaka, Tokyo (JP); Satoru Ogasawara, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/105,280

(22) Filed: Apr. 13, 2005

(30) Foreign Application Priority Data
Apr. 15, 2004 (JP) 2004-120590

(51) Int. Cl. B60H 1/00

(52) U.S. Cl. 248/652

(57) ABSTRACT

There is provided a haptic feedback input device of which a manipulation section is not vertically tilted even when a vertical impact is applied to a vehicle body. As support means for supporting a coupled body 16 of a manipulation section 6 and a motor 8 to be tiltable only in the horizontal direction, a pair of tilt axes 19 protruded from the upper and lower portions of a front engine cover 12 and a pair of tongues 20, which are provided inside a rear case 4 and which has an axial bore 20A into which the tilt axis 19 is rotatably inserted, are provided.

### BACKGROUND OF THE INVENTION

1. Field of the Invention

The present invention relates to a haptic feedback input device mounted in a vehicle, comprising a manipulation section which is rotated and tilted and a motor supplying rotary power to the manipulation section to give haptic feedback such as predetermined click touch at the time of rotation of the manipulation section.

2. Description of the Related Art

Conventional haptic feedback input devices are mounted in vehicles and are used to manipulate vehicle-mounted electrical instruments such as car air-conditioners, radio receivers, televisions, CD players, etc. The conventional haptic feedback input devices have a motor, a manipulation section which receives rotary power from the motor and is manually rotated, rotation-angle detection means for detecting a rotation angle of the manipulation section, and control means for controlling the motor such that the haptic feedback such as click touch corresponding to the rotation angle detected by the rotation-angle detection means is generated in the manipulation section. In addition, the conventional haptic feedback input device comprises support means for tiltably support a coupled body of the manipulation section and the motor, tilt detection means for detecting a tilt direction of the coupled body, and restoration means for restoring the coupled body to a neutral position. Here, the manipulation section can be tilted by hands.

The manipulation section is coupled to the motor through engagement with the output shaft of the motor, thereby forming the coupled body.

A guide plate for regulating the tilt direction and the amount of tilt of the coupled body is provided at the lower portion of the motor. Radial guide grooves extending in eight directions from the center are formed in the guide plate, and the output shaft of the motor is inserted in the guide grooves. That is, the tilt direction of the output shaft of the motor is regulated in the eight directions by the guide grooves of the guide plate, and the amount of tilt of the manipulation section is regulated by the length of the respective grooves extending radially from the center of the guide grooves. In this way, the tilt direction and the amount of tilt of the manipulation section are regulated.

The conventional haptic feedback input devices have a case which houses the motor and the coupled body such that the manipulation section is protruded. The manipulation section is protruded in a direction approximately perpendicular to the surface of the case.

The case is provided in an instrumental panel. In the case provided in the instrumental case, the surface of the case from which the manipulation section is protruded has a tilted upper surface. That is, in a state where a vehicle is horizontal, the coupled body of the manipulation section and the motor is oblique to the upside about the horizontal plane.

In the haptic feedback input device having the above-mentioned structure, when a large impact is vertically applied to a vehicle body such as when the vehicle travels on an uneven road, the force of inertia in the tilt direction acts on the coupled body due to the weight of the motor. However, since the coupled body of the manipulation section and the motor is disposed oblique to the upside about the horizontal plane, such small force of inertia acts that the manipulation section cannot be tilted vertically.

That is, in the conventional haptic feedback input device, since the coupled body of the manipulation section and the motor is disposed oblique to the upside about the horizontal plane, the vertical tilt of the manipulation section due to the vertical impact on the vehicle body is prevented.

[Patent Document 1] Japanese Unexamined Patent Application Publication No. 2002-149321

As installation patterns of the haptic feedback input device, an installation pattern in which the coupled body is disposed approximately horizontal can be considered, in addition to the above-mentioned installation pattern in which the coupled body of the manipulation section and the motor is disposed oblique to the upside.

However, when the coupled body is disposed approximately horizontal, the force of inertia in the tilt direction acting on the coupled body due to the weight of the motor when a large vertical impact is applied to the vehicle becomes greater than that of the conventional haptic feedback input device. Accordingly, the vertical tilt of the manipulation section not intended by an operator may be brought about.

### SUMMARY OF THE INVENTION

The present invention is contrived in view of the above-mentioned situation. It is an object of the present invention to provide a haptic feedback input device of which a manipulation section is not vertically tilted even when a vertical impact is applied to a vehicle.

In order to accomplish the above-mentioned object, the present invention provides Aspects 1 to 4 as follows.

According to Aspect 1 of the present invention, there is provided a haptic feedback input device comprising: a manipulation section which is tilted and rotated; a motor which is coupled to the manipulation section to deliver rotary power to the manipulation section and is tilted in response to the tilt manipulation of the manipulation section; support means for tiltably supporting a coupled body of the manipulation section and the motor; detection means for detecting the tilt of the coupled body; and restoration means for restoring the coupled body to a neutral position from a tilted position, wherein the support means mounts the coupled body to a vehicle such that a rotation axis of the manipulation section is approximately horizontal, and supports the coupled body to be tiltable only in an approximately horizontal direction.

In the present invention having the above-mentioned construction, the support means is provided which supports the coupled body of the manipulation section and the motor to be tiltable only in the horizontal direction in a state where the vehicle is approximately horizontal. That is, the coupled body of the manipulation section and the motor is not tilted in the vertical direction by the force of inertia due to the weight of the motor. As a result, even when a vertical impact is applied to the vehicle, the manipulation section is not tilted in the vertical direction.

According to Aspect 2 of the present invention, there is provided the haptic feedback input device according to Aspect 1 further comprising a case which houses the motor and the coupled body such that the manipulation section is protruded, wherein a designed portion indicating a tiltable direction of the manipulation section may be formed on the surface of the case from which the manipulation section is protruded. Examples of the designed portion may include protruded portions or recessed portions formed in the surface of the case or figures formed on the surface of the case with paint.

In the present invention having the construction of Aspect 2, since the designed portion indicates that the manipulation section can be tilted only in the horizontal direction, an operator is suppressed to vertically tilt the manipulation section.

According to Aspect 3 of the present invention, there is provided the haptic feedback input device according to Aspect 2, wherein the designed portion is formed around the manipulation section and includes a recessed portion extending in the tiltable direction of the manipulation section.

In the present invention having the construction of Aspect 3, a hint that the manipulation section can be tilted only in the horizontal direction can be given by the recessed portion extending in the tiltable direction of the manipulation section.

According to Aspect 4 of the present invention, there is provided the haptic feedback input device according to Aspect 2, wherein the designed portion includes a mark indicating the tiltable direction of the manipulation section. The mark indicates a direction with one vertex such as an arrow or a triangular mark.

In the present invention having the construction of Aspect 4, it can be clearly indicated by an arrow or a triangular mark that the manipulation section can be tilted only in the horizontal direction.

As described above, according to the present invention, the manipulation section is not tilted in the vertical direction even when a vertical impact is applied to the vehicle. Therefore, the vertical tilt of the manipulation section not intended by an operator cannot be brought about.

### BRIEF DESCRIPTION OF THE DRAWINGS

FIG. 1 is a front view illustrating a manipulation device comprising a haptic feedback input device according to an embodiment of the present invention;

FIG. 2 is an exploded perspective view of the manipulation device shown in FIG. 1;

FIG. 3 is a cross-sectional view taken along Line III-III of FIG. 1;

FIG. 4 is a cross-sectional view taken along Line IV-IV of FIG. 1;

FIG. 5 is a cross-sectional view taken along Line V-V of FIG. 4; AND

FIG. 6 is a block diagram illustrating a system structure of the manipulation device shown in FIG. 1.

### DESCRIPTION OF THE PREFERRED EMBODIMENT

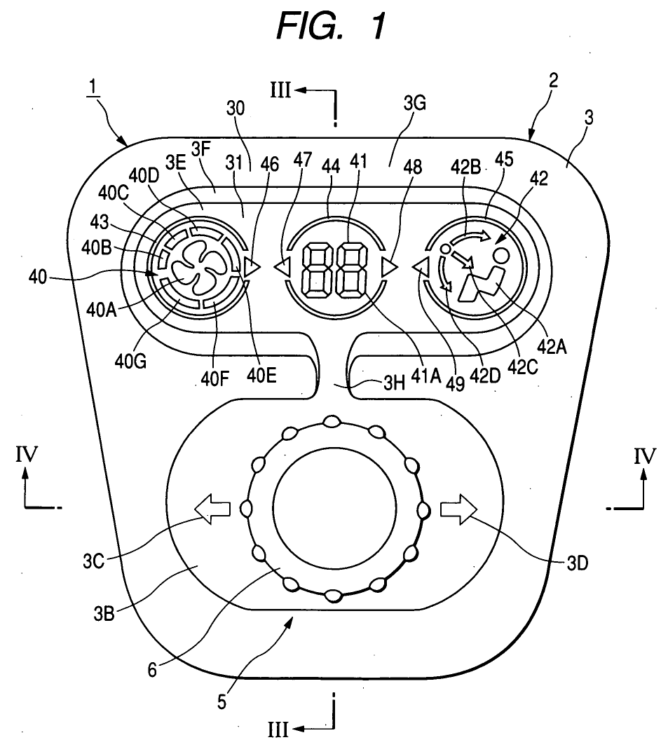

Hereinafter, an embodiment of a haptic feedback input device according to the present invention will be described with reference to FIGS. 1 to 6.

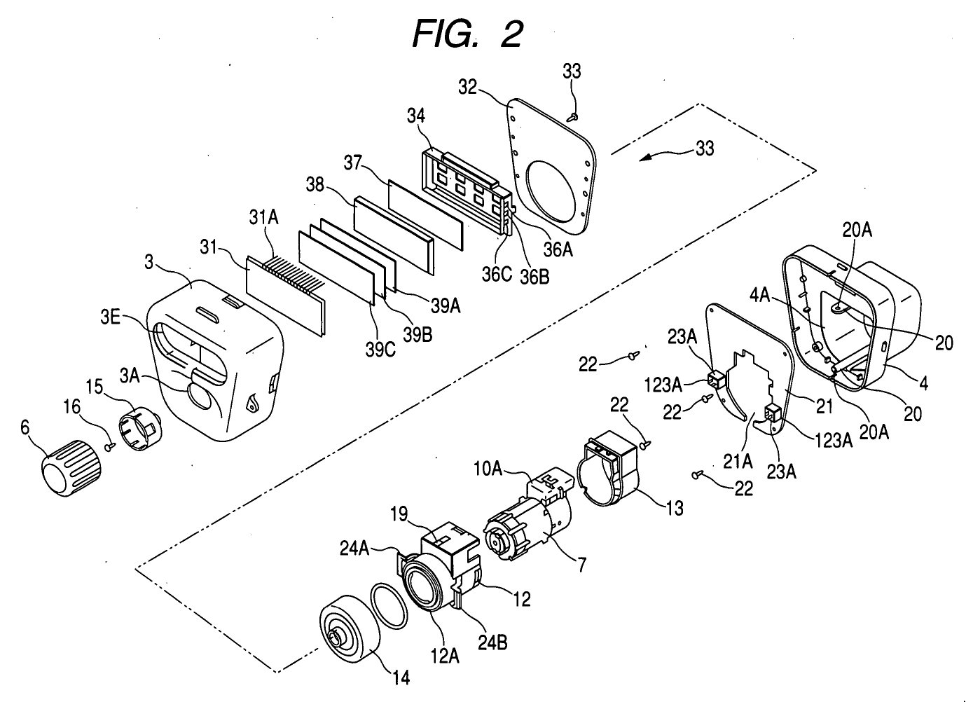

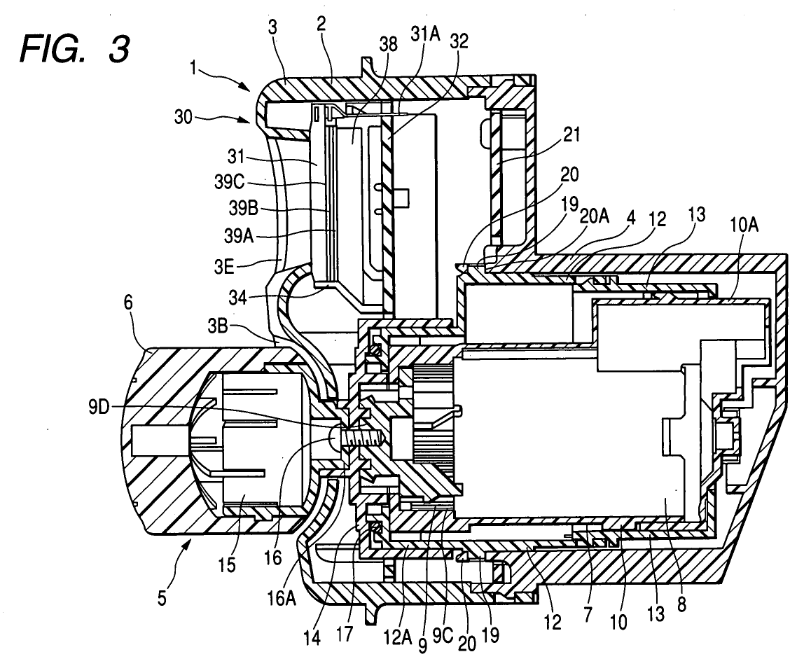

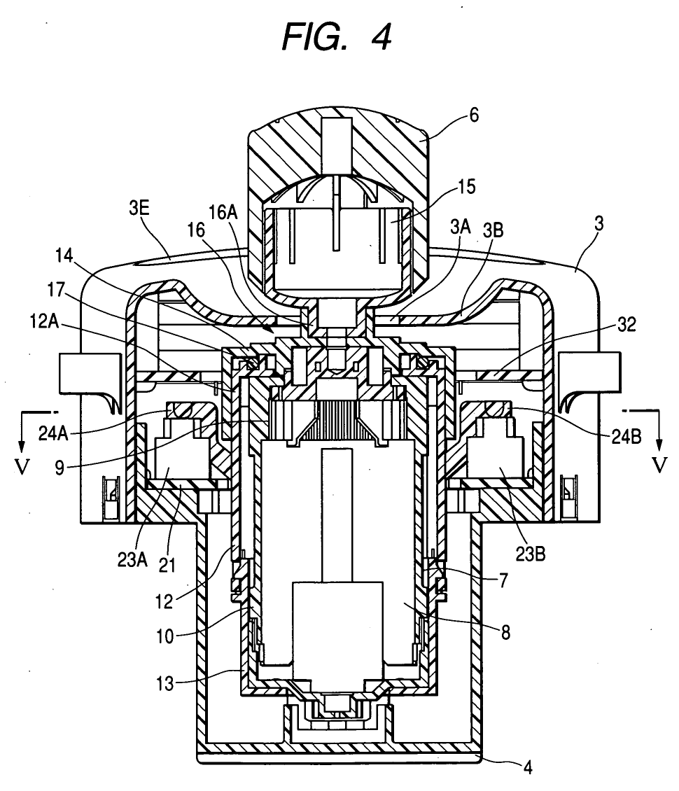

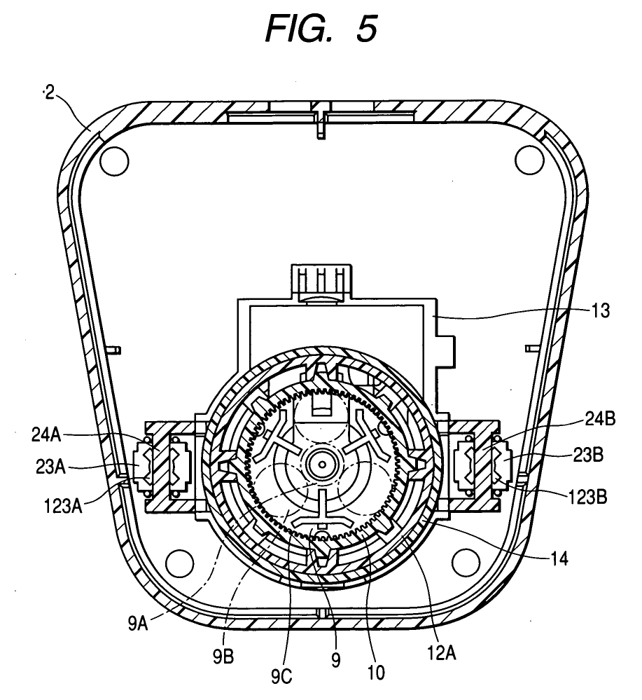

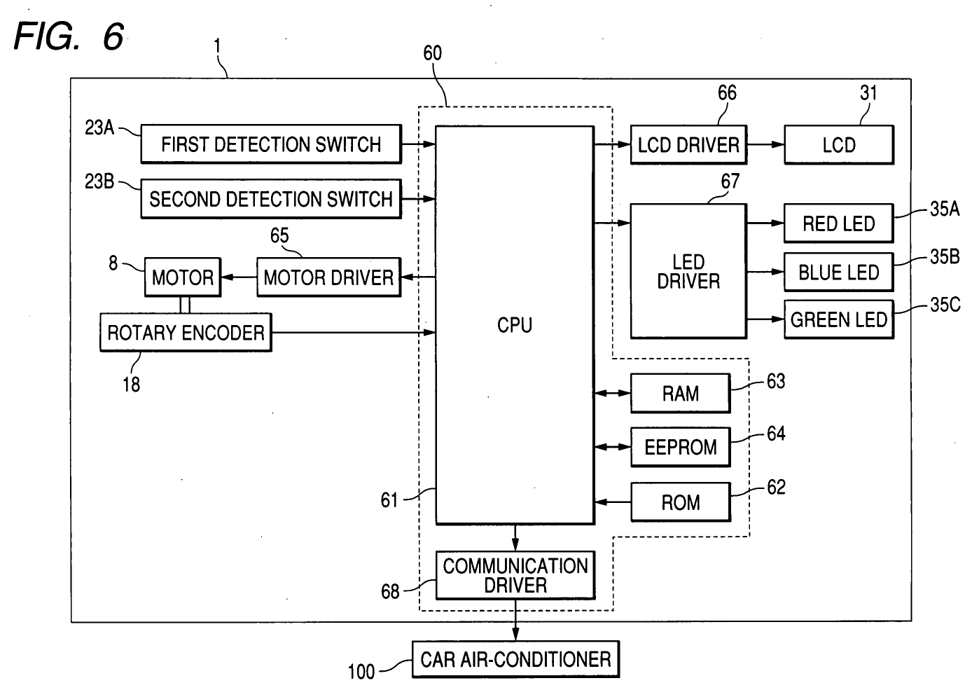

FIG. 1 is a front view of a haptic feedback input device according to the present invention, FIG. 2 is an exploded perspective view of a manipulation section shown in FIG. 1, FIG. 3 is a cross-sectional view taken along Line III-III of FIG. 1, FIG. 4 is a cross-sectional view taken along Line IV-IV of FIG. 1, FIG. 5 is a cross-sectional view taken along Line V-V of FIG. 4, and FIG. 6 is a block diagram illustrating a system structure of a manipulation device shown in FIG. 1.

The present embodiment provides a haptic feedback input device 5 fitted to a manipulation device 1 shown in FIG. 1. The manipulation device 1 is used to manipulate vehicle-mounted electrical instruments such as a car air-conditioner 100 (see FIG. 6).

<1> Construction of Manipulation Device 1

The manipulation device 1 comprises the haptic feedback input device 5, a display device 30 for displaying set items of a car air-conditioner 100 such as set statuses of air flow, temperature, and vent, and a controller 60 for controlling the haptic feedback input device 5 and the display device 30 and outputting instruction signals to the car air-conditioner 100.

In FIG. 1, reference numeral 6 denotes a manipulation section provided in the haptic feedback input device 5, and reference numeral 31 denotes an LCD which is provided in the display device and which displays the set statuses of air flow, temperature, and vent of the car air-conditioner 100. In the manipulation device 1, the manipulation section 3 is disposed below the LCD 31 and is provided in an instrumental panel (not shown) of a vehicle to be horizontally protruded from a case 2.

<1.1> Construction of Haptic Feedback Input Device

The construction of the haptic feedback input device will be described with reference to FIGS. 2 to 5.

The haptic feedback input device 5 comprises a case 2. The case 2 has a front case 3 and a rear case 4 snap-coupled. The manipulation section 6 which is manually rotated and tilted is disposed at the front side of the front case 3.

An engine 7 unified by covering a motor 8 and an epicyclic gear mechanism 9 with a cover 10 is housed in the case 2, where the epicyclic gear mechanism is fitted to an output shaft of the motor 8 and amplifies and outputs rotary power of the output shaft.

The epicyclic gear mechanism 9 comprises a sun gear 9A being fixed to the output shaft of the motor 8 and integrally rotating with the output shaft, three planet gears 9B revolving about the sun gear 9A, a ring gear 9C being formed on the inner wall of the cover 10 and engaging with the planet gears 9B at the inner circumference, a carrier 9D being provided with the rotation axes of the planet gears 9B and rotating in conjunction with the revolution of the planet gears 9B (see FIG. 5).

The engine 7 is covered with a front engine cover 12 which is fitted to a front side of the engine 7 and has a cylindrical portion 12A and a rear engine cover 13 which is fitted to a rear side of the engine 7 and is snap-coupled to the front engine cover 12.

The output shaft of the carrier 9D is disposed at the inner circumference of the cylindrical portion 12A of the front engine cover 12. A guide member 14 for guiding the rotation of the manipulation section 6 is slidably fitted to the outer circumference of the cylindrical portion 12A. A manipulation section holder 15 being snap-coupled to the manipulation section 6 is disposed at the center of the front end surface of the guide member 14. The manipulation holder 15, the guide member 14, and the carrier 9D are fastened with a screw 16.

That is, in the haptic feedback input device 5, a coupled body 16 of the manipulation section 6 and the motor 8 coupled to each other by the manipulation section holder 15, the guide member 14, the front engine cover 12, the epicyclic gear mechanism 9, and the rear engine cover 13 is formed. The rotary power is delivered between the manipulation section 6 and the motor 8 through the manipulation holder 15, the guide member 14, and the epicyclic gear mechanism 9.

An O ring 17 is fitted to the front end surface of the front engine cover 12. Grease (not shown) is filled between the outer circumference of the cylindrical portion 12A of the front engine cover 12 and the inner circumference of the guide member 14.

The engine 7 is provide with a rotary encoder 18 (see FIG. 6) which detects a rotation angle of the manipulation section 6, that is, a rotation angle of the output shaft of the motor 8 and outputs a rotation angle signal corresponding to the detected rotation angle. The rotary encoder 18 comprises a code plate and a photo sensor, which are not shown. The photo sensor is received in a box-shaped portion 10A formed in the cover 10.

The haptic feedback input device 5 comprises support means for supporting the coupled body 16 to be tiltable only in the horizontal direction (the left-right direction in FIG. 1). The support means includes, for example, a pair of tilt axes 19 protruded from the upper and lower portions of the front engine cover 12 and a pair of tongues 20 having an axial bore 20A which is provided inside the rear case 4 and into which the respective tilt axes 19 are inserted rotatably. The support means may be constructed such that the axial bores are formed in the front engine cover 12 and the tilt axes are formed in the rear case 4.

A first circuit board 21 is fixed to the rear case 4 with screws 22. The left and right sides of the front surface of the first circuit board 21 are provided with first and second detection switches 23A and 23B. The first and second detection switches 23A and 23B comprise a driving member 123A which can reciprocate in the front-rear direction, a movable contact (not shown) and a fixed contact (not shown) which can come in contact with and be separated from each other in response to the reciprocation of the driving member 123A, and an elastic member (not shown) for restoring the driving member 123A. First and second manipulation pieces 24A and 24B for manipulating the driving member 123A of the first detection switch 23A and the driving member 123A of the second detection switch 23B in response to the tilt of the coupled body 16 are protruded from both sides of the front engine cover 12.

That is, in the haptic feedback input device 5, the first and second detection switches 23A and 23B and the manipulation pieces 24A and 24B constitute tilt detection means for detecting the tilt direction of the coupled body 16 and restoration means for restoring the coupled body 16 to a neutral position.

The first circuit board 21 is provided with control means for controlling the motor 8 such that the haptic feedback such as click touch corresponding to the rotation angle detected by the rotary encoder 18 is generated in the manipulation section 6. The control means comprises a controller 60 (see FIG. 6) for calculating the rotary power of the motor 8 according to the rotation angle detected by the rotary encoder 18 and outputting an instruction signal corresponding to the calculated rotary power and a motor driver 65 for driving the motor 8 in accordance with the instruction signal from the controller 60.

In addition to outputting an instruction to the motor driver 65, the controller 60 can calculate an instruction value for the car air-conditioner 100 in accordance with the tilt direction detected by the first and second detection switches 23A and 23B and the rotation angle detected by the rotary encoder 18, and output an instruction signal corresponding to the instruction value to the car air-conditioner 100 through a communication driver 68.

A coupled portion 16A of the manipulation section holder 15 and the guide member 14 is disposed in the front case 3. A laterally-long hole 3A permitting movement of the coupled portion 16A accompanied with the tilt of the coupled body 16 is also formed in the front case. Around the laterally-long hole 3A, there is provided a designed portion indicating the tiltable direction of the manipulation section 6, that is, a laterally-long recessed portion 3B formed in the front case 3 and a left arrow 3C and a right arrow 3D drawn on the bottom surface of the recessed portion 3B.

A portion of the coupled body 16 positioned at the rear side of the tilt axes 19 is disposed in the rear case 4 and the first circuit board 21. A reception portion 4A and an opening portion 21A for permitting the tilt of the coupled body 16 are formed in the rear case 4 and the first circuit board 21, respectively.

<1.2> Construction of Display Device 30

The display device 30 will be described with reference to FIGS. 1 and 2.

The display device 30 is housed in the same case 2 as the haptic feedback input device 5. A window portion 3E for exposing the surface (the display plane) of the LCD 31 is formed in the front case 3. The window portion 3E has a shape similar to the front shape of the recessed portion 3B in which the manipulation section 6 is disposed. That is, the window portion 3E is formed laterally long and both sides are formed in a semicircular shape, similarly to the recessed portion 3B. The end profile shape of the window portion 3E and the end profile shape of the recessed portion 3B are similar to each other. The upper half of the front case 3 includes a frame portion 3G in which the window portion 3E is formed, and a slope portion 3F is formed in the inner circumference of the frame portion 3G. The window portion 3E forms a recessed portion inwardly recessed in the front case 3 by the frame portion 3G. In addition, a groove 3H for allowing the window portion 3E to communicate with the recessed portion 3B is formed in the front case 3.

The case 2 houses the LCD 31, a second circuit board 32 to which terminals 31A of the LCD 31 are connected, and an LCD holder 34 to which the LCD 31 is fitted and which is fixed to the second circuit board 32. The second circuit board 32 is fixed to the front case 3 with a screw 33. The second circuit board 32 is provided with an LCD driver 66 (see FIG. 6) for driving the LCD 31. The LCD driver 66 drives the LCD 31 in accordance with the instruction signal from the controller 60.

One side of the LCD holder 34, for example, the right side thereof, is provided with light-source fitting holes 36A to 36C for fitting a red LED 35A, a blue LED 35B, and a green LED 35C thereto. The LEDs 35A to 35C are electrically connected to the second circuit board 32 through lead lines. The second circuit board 32 is also provided with an LED driver 67 for controlling the LEDs 35A to 35C. The LED driver 67 controls the LEDs 35A to 35C in accordance with the instruction signal from the controller 60.

A reflecting film 37 reflecting light is attached to the entire bottom surface of the LCD holder 34. A light guide film 38 for guiding the light emitted from the LEDs 35A to 35C and the light reflected by the reflective film 37 to the rear side of the LCD 31 and three spread sheets 39A to 39C for spreading the light guided by the light guide film 38 uniformly to the rear surface of the LCD 31 are disposed between the reflecting film 37 and the LCD 31.

The surface portion of the LCD 31 exposed from the window portion 3E of the front case 3 is provided with an air-flow display area 40 displaying a set status of air flow, a temperature display area 41 displaying a set status of temperature, and a vent display area 42 displaying a set status of vent.

A fan-shaped segment 40A and six circular arc-shaped segments 40B to 40G surrounding the fan-shaped segment 40A can be marked in the air-flow display area 40. That is, the air flow of 0, that is, the stop status of the car air-conditioner 100, is displayed by the light emission of only the fan-shaped segment 40A. The magnitude of air flow is displayed in six steps of the light emission of only the circular arc-shaped segment 40B, the light emission of the circular arc-shaped segments 40B and 40C, the light emission of the circular arc-shaped segments 40B to 40D, the light emission of the circular arc-shaped segments 40B to 40E, the light emission of the circular arc-shaped segments 40B to 40F, and the light emission of the circular arc-shaped segments 40B to 40G.

A plurality of segments capable of forming a numeral of two ciphers 41A can be displayed in the temperature display area 41. The set values of temperature can be displayed in the numeral 41A by 1° C. in a range of 16° C. to 30° C.

A human-shaped segment 42A, an arrow-shaped segment 42B extending to the upside of the human-shaped segment 42A, an arrow-shaped segment 42C extending to the center of the human-shaped segment 42A, and an arrow-shaped segment 42D extending to the downside of the human-shaped segment 42A can be displayed in the vent display area 42. That is, the status of DEF vent for sending air to the front windshield is displayed by the light emission of the arrow-shaped segment 42B, the status of VENT for sending air to the body of a driver is displayed by the light emission of the arrow-shaped segment 42C, and the status of FLOOR vent for sending air to the downside of the driver is displayed by the light emission of the arrow-shaped segment 42D.

Ring-shaped segments 43 to 45 can be displayed to surround the air-flow display area 40, the temperature display area 41, and the vent display area 42, respectively. That is, among the three set items, the selection of air flow is displayed by the light emission of the ring-shaped segment 43, the selection of temperature is displayed by the light emission of the ring-shaped segment 44, and the selection of vent is displayed by the light emission of the ring-shaped segment 45.

A triangular segment 46 of which a vertex faces the right side can be displayed at the right side of the ring-shaped segment 43. A triangular segment 47 of which a vertex faces the left side can be displayed at the left side of the ring-shaped segment 44 and a triangular segment 48 of which a vertex faces the right side can be displayed at the right side thereof. A triangular segment 49 of which a vertex faces the left side can be displayed at the left side of the ring-shaped segment 45.

<1.3> Construction of Controller 60

A construction of the controller 60 will be described with reference to FIG. 6.

The controller 60 comprises a CPU 61, a ROM 62, a RAM 63, an EEPROM 64, and a communication driver 68. As described above, the controller 60 outputs instruction signals corresponding to an instruction value for the motor driver 65, an instruction value for the LCD driver 66, an instruction value for the LED driver 67, and an instruction value for the car air-conditioner 100, in accordance with the detection signal from the first and second detection switches 23A and 23B and the rotation angle signal from the rotary encoder 18.

The CPU 61 serves as a computer performing an operation for calculating the respective instruction values for the motor driver 65, the LCD driver 66, and the LED driver 67, and the car air-conditioner 100 or an operation for controlling the whole controller 60, in accordance with the detection signals from the first and second detection switches 23A and 23B and the rotation angle signal from the rotary encoder 18.

The ROM 62 is a read only memory for storing a start program for starting up the manipulation device 1 in interlock with the start of a vehicle engine and a program for outputting an instruction signal for the motor driver 65, an instruction signal for the LCD driver 66, an instruction signal for the LED driver 67, and an instruction signal for the car air-conditioner 100 in accordance with the rotation angle signal detected by the rotary encoder 18 and the tilt direction of the manipulation section 6 detected by the first and second detection switches 23A and 23B, respectively. In the start program, a mode (temperature setting mode) where the set status of temperature can be changed is established.

The RAM 63 is a memory for temporarily storing the values under operation of the CPU 61.

The EEPROM 64 is a memory of which stored contents can be changed. The EEPROM stores the instruction value for the LCD driver 66, the instruction value for the LED driver 67, and the instruction value for the car air-conditioner 100 corresponding to the respective set statuses of air flow, temperature, and vent.

<2> Operation of Manipulation Device 1

The operation of the manipulation device 1 will be described.

<2.1> Start of Manipulation Device 1

The manipulation device 1 is started in interlock with the start of the vehicle engine and is set to the temperature setting mode.

At this time, for example, the numeral 41A of “22” indicating that the temperature is set to “22° C.” is displayed in the temperature display area 41. The air flow of “0” is displayed by the light emission of only the fan-shaped segment 40A in the air-flow display area 40 of the LCD 31. The setting of “VENT” is displayed by the light emission of the arrow-shaped segment 42C in the vent display area 42.

The ring-shaped segment 44 and the triangular segments 47 and 48 surrounding the temperature display area 41 emit light, but the ring-shaped segment 43 and the triangular segment 46 surrounding the air-flow display segment 40 and the ring-shaped segment 45 and the triangular segment 49 surrounding the vent display area 42 do not emit light. That is, the temperature setting mode is displayed by the ring-shaped segment 44, and it is displayed by the triangular segments 47 and 48 that it can be switched to the air flow setting mode or the vent setting mode by means of the horizontal tilt manipulation of the manipulation section 6.

When the instruction value corresponding to the set status of 22° C. in the temperature setting mode is supplied to the LED driver 67 from the controller 60, for example, the red LED 35A and the blue LED 35B emit light and thus the backlight of the LCD 31 becomes violet.

<2.2> Setting Temperature

The setting manipulation of temperature is performed by rotating the manipulation section 6 in the temperature setting mode.

When the manipulation section 6 is rotated to right, the increase in rotation angle of the manipulation section 6 is detected by the rotary encoder 18 and the rotation angle signal corresponding to the detected rotation angle is output to the controller 60. In response to the increase in rotation angle, the controller 60 calculates the instruction value for the LCD driver 66, the instruction value for the LED driver 67, and the instruction value for the motor driver 65, respectively, and outputs the instruction signals corresponding to the instruction values to the LCD driver 66, the LED driver 67, and the motor driver 65, respectively.

As a result, the value of the numeral 41A increases in the temperature display area 41 of the LCD 31 every time the rotation angle of the manipulation section 6 increases by a predetermined angle.

The violet backlight becomes deeper in red with the increase in rotation angle of the manipulation section 6, and becomes full red when the value of the numeral 41A becomes “30” as the upper limit (30° C.) of the setting value of temperature.

The rotary power of the motor 8 is instantly varied every time the rotation angle of the manipulation section 6 increases by the predetermined angle, thereby generating click touch in the manipulation section 6. That is, an operator feels the click touch every time the value of the numerical 41A indicating temperature increases. When the value of the numeral 41A reaches “30” in the temperature display area 41, a great rotary power against the right rotation is applied to the manipulation section 6 from the motor 8 and the right rotation of the manipulation section 6 by the operator is suppressed. That is, the operator is informed by the suppression (haptic feedback) of the right rotation of the manipulation section 6 that the set value of temperature reaches the maximum (30° C.).

When the manipulation section 6 is rotated to left, the decrease in rotation angle of the manipulation section 6 is detected by the rotary encoder 18 and the rotation angle signal corresponding to the detected rotation angle is output to the controller 60. In response to the decrease in rotation angle, the controller 60 calculates the instruction value for the LCD driver 66, the instruction value for the LED driver 67, and the instruction value for the motor driver 65, respectively, and outputs the instruction signals corresponding to the instruction values to the LCD driver 66, the LED driver 67, and the motor driver 65, respectively.

As a result, the value of the numeral 41A decreases in the temperature display area 41 of the LCD 31 every time the rotation angle of the manipulation section 6 decreases by a predetermined angle.

The violet backlight becomes deeper in blue with the decrease in rotation angle of the manipulation section 6, and becomes full blue when the value of the numeral 41A becomes “16” as the lower limit (16° C.) of the setting value of temperature.

The rotary power of the motor 8 is instantly varied every time the rotation angle of the manipulation section 6 decreases by the predetermined angle, thereby generating click touch in the manipulation section 6. That is, the operator feels the click touch every time the value of the numerical 41A indicating temperature decreases. When the value of the numeral 41A reaches “16” in the temperature display area 41, a great rotary power against the left rotation is applied to the manipulation section 6 from the motor 8 and the left rotation of the manipulation section 6 by the operator is suppressed. That is, the operator is informed by the suppression (haptic feedback) of the left rotation of the manipulation section 6 that the set value of temperature reaches the minimum (16° C.).

When the rotation angle detected by the rotary encoder 18 does not vary for two seconds, the controller 60 determines that the manipulation of setting the temperature is finished, and calculates the instruction value for the car air-conditioner 100 from the difference between the rotation angle detected by the rotary encoder 18 at the time of the start of manipulation and the rotation angle detected by the rotary encoder 18 at the time of the end of manipulation. Then, the instruction signal corresponding to the calculated instruction value is output to the car air-conditioner 100 through the communication driver 68.

<2.3> Setting Air Flow

The manipulation of setting air flow is performed by tilting the manipulation section 6 to left to switch the temperature setting mode to the air flow setting mode and then rotating the manipulation section 6.

When the coupled body 16 is tilted to left with the tilt of the manipulation section 6 to left, the driving member 123A is pressed by the first manipulation piece 24A to turn on the first detection switch 23A, and a detection signal indicating that the manipulation section 6 is tilted to left is output to the controller 60 from the first detection switch 23A. Thereafter, when the driving member 123A is restored to turn off the first detection switch 23A, the output of the detection signal to the controller 60 is stopped. The controller 60 processes the output and stop of the detection signal from the first detection switch 23A in the temperature setting mode as an instruction indicating the switching to the air flow setting mode, and thus the manipulation device 1 is switched to the air flow setting mode.

Then, the air flow “0” is displayed by the light emission of only the fan-shaped segment 40A in the air flow display area 40 of the LCD 31 as displayed at the time of starting, the set value of temperature set as described above is displayed by the numeral 41A in the temperature display area 41, and the vent “VENT” is displayed by the light emission of the arrow-shaped segment 42A in the vent display area 42 as displayed at the time of starting.

The ring-shaped segment 43 and the triangular segment 46 surrounding the air flow display area 40 emit light and the light of the ring-shaped segment 44 and the triangular segments 47 and 48 surrounding the temperature display area 41 disappears. That is, the air flow setting mode is displayed by the ring-shaped segment 43, and the triangular segment 46 indicates that it can be switched to the temperature setting mode by means of the right tilt manipulation of the manipulation section 6.

The instruction value corresponding to the set value “0” of air flow in the air flow setting mode is supplied to the LED driver 67 from the controller 60. As a result, for example, only the green LED 35C emits light, and thus the backlight of the LCD 31 becomes green.

When the manipulation section 6 is rotated to right, the increase in rotation angle of the manipulation section 6 is detected by the rotary encoder 18 and the rotation angle signal corresponding to the detected rotation angle is output to the controller 60. In response to the increase in rotation angle, the controller 60 calculates the instruction value for the LCD driver 66, the instruction value for the LED driver 67, and the instruction value for the motor driver 65, respectively, and outputs the instruction signals corresponding to the instruction values to the LCD driver 66, the LED driver 67, and the motor driver 65, respectively.

As a result, in the air flow display area 40 of the LCD 31, the circular arc-shaped bars 40B to 40G emit light in the order of 40B, 40C, 40D, 40E, 40F, and 40G every time the rotation angle of the manipulation section 6 increases by predetermined different angles at the time of setting the air flow or setting the vent to be described later.

The green backlight becomes brighter in green with the increase in rotation angle of the manipulation section 6 by the predetermined different angles, and becomes the brightest when the circular arc-shaped segment 40G emits light in the air flow display area 40.

The rotary power of the motor 8 is instantly varied every time the rotation angle of the manipulation section 6 increases by the predetermined different angles, thereby generating click touch in the manipulation section 6. That is, an operator feels the click touch every time the respective circular arc-shaped segments 40B, 40C, 40D, 40E, 40F, and 40G emit light. When all the circular arc-shaped segments 40B to 40G in the air flow display area 40 emit light to display the upper limit of air flow, a great rotary power against the right rotation is applied to the manipulation section 6 from the motor 8 and the right rotation of the manipulation section 6 by the operator is suppressed. That is, the operator is informed by the suppression (haptic feedback) of the right rotation of the manipulation section 6 that the set value of air flow reaches the maximum.

When the manipulation section 6 is rotated to left, the decrease in rotation angle of the manipulation section 6 is detected by the rotary encoder 18 and the rotation angle signal corresponding to the detected rotation angle is output to the controller 60. In response to the decrease in rotation angle, the controller 60 calculates the instruction value for the LCD driver 66, the instruction value for the LED driver 67, and the instruction value for the motor driver 65, respectively, and outputs the instruction signals corresponding to the instruction values to the LCD driver 66, the LED driver 67, and the motor driver 65, respectively.

As a result, at the time of starting the left rotation of the manipulation section 6, for example, when all the circular arc-shaped segments 40D to 40G emit light, the light of the circular arc-shaped bars 40B to 40G disappears in the order of 40G, 40F, 40E, 40D, 40C, and 40B every time the rotation angle of the manipulation section 6 decreases by predetermined different angles.

The green backlight becomes darker in green with the decrease in rotation angle of the manipulation section 6 by the predetermined different angles, and becomes the darkest when the air flow “0” is displayed by the light emission of only the fan-shaped segment 40A.

The rotary power of the motor 8 is instantly varied every time the rotation angle of the manipulation section 6 decreases by the predetermined different angles, thereby generating click touch in the manipulation section 6. That is, an operator feels the click touch every time the light of the circular arc-shaped segments 40B to 40G disappear in the order of 40G, 40F, 40E, 40D, 40C, and 40B. When the air flow “0” is displayed in the air flow display area 40, a great rotary power against the left rotation is applied to the manipulation section 6 from the motor 8 and the left rotation of the manipulation section 6 by the operator is suppressed. That is, the operator is informed by the suppression of the left rotation of the manipulation section 6 that the set value of air flow is “0”.

When the rotation angle detected by the rotary encoder 18 does not vary for two seconds, the controller 60 determines that the manipulation of setting the air flow is finished, and calculates the instruction value for the car air-conditioner 100 from the difference between the rotation angle detected by the rotary encoder at the time of starting the air flow setting manipulation and the rotation angle detected by the rotary encoder 18 at the time of finishing the air flow setting manipulation. Then, the instruction signal corresponding to the calculated instruction value is output to the car air-conditioner 100 through the communication driver 68.

When the output of the instruction signal through the communication driver 68 is finished, the controller 60 performs the operation of switching to the temperature setting mode and thus the manipulation device 1 is restored to the temperature setting mode.

<2.4> Setting Vent

The manipulation of setting the vent is performed by tilting the manipulation section 6 to right to switch the temperature setting mode to the vent setting mode and then rotating the manipulation section 6.

When the coupled body 16 is tilted to right with the tilt of the manipulation section 6 to right, the driving member 123A is pressed by the second manipulation piece 24B to turn on the second detection switch 23B, and a detection signal indicating that the manipulation section 6 is tilted to right is output to the controller 60 from the second detection switch 23B. Thereafter, when the driving member 123A is restored to turn off the second detection switch 23B, the output of the detection signal to the controller 60 is stopped. The controller 60 processes the output and stop of the detection signal from the second detection switch 23B in the temperature setting mode as an instruction indicating the switching to the vent setting mode, and thus the manipulation device 1 is switched to the vent setting mode.

Then, the vent “VENT” is displayed by the light emission of the arrow-shaped segment 42C in the vent display area 42 as displayed at the time of starting, the temperature set as described above is displayed in the temperature display area 41, and the air flow set as described above is displayed in the air flow display area 40 of the LCD 31.

The ring-shaped segment 45 and the triangular segment 49 surrounding the vent display area 42 emit light, and the light of the ring-shaped segment 44 and the triangular segments 47 and 48 surrounding the temperature display area 41 and the light of the ring-shaped segment 43 and the triangular segment 46 surrounding the air flow display area 40 disappear. That is, the vent setting mode is displayed by the ring-shaped segment 45, and the triangular segment 49 indicates that it can be switched to the temperature setting mode by means of the left tilt manipulation of the manipulation section 6.

The instruction value corresponding to the vent setting mode is supplied to the LED driver 67 from the controller 60. As a result, for example, all of the red LED 35A, the blue LED 35B, and the green LED 35C emit light with a predetermined brightness, and thus the backlight of the LCD 31 becomes white.

When the manipulation section 6 is rotated, the variation in rotation angle of the manipulation section 6 is detected by the rotary encoder 18 and the rotation angle signal corresponding to the detected rotation angle is output to the controller 60. In response to the variation in rotation angle, the controller 60 calculates the instruction value for the LCD driver 66, the instruction value for the LED driver 67, and the instruction value for the motor driver 65, respectively, and outputs the instruction signals corresponding to the instruction values to the LCD driver 66, the LED driver 67, and the motor driver 65, respectively.

As a result, in the vent display area 42 of the LCD 31, when the rotation angle of the manipulation section 6 increases, the arrow-shaped segment 42C (only “VENT”) emitting light is sequentially switched to 42D (only “FLOOR”), 42B (only “DEF”), the combination of 42B and 42D (“DEF” and “FLOOR”), and the combination of 42C and 42D (“VENT” and “FLOOR”) every time the rotation angle increases by predetermined different angles at the time of setting the air flow or setting the temperature. On the contrary, when the rotation angle of the manipulation section 6 decreases, the arrow-shaped segment 42C (only “VENT”) emitting light is sequentially switched to the combination of 42C and 42D (“VENT” and “FLOOR”), the combination of 42B and 42D (“DEF” and “FLOOR”), 42B (only “DEF”), and 42D (only “FLOOR”) every time the rotation angle decreases by the predetermined different angles.

The rotary power of the motor 8 is instantly varied every time the rotation angle of the manipulation section 6 varies by the predetermined different angles, thereby generating click touch in the manipulation section 6. That is, the operator feels the click touch when the arrow-shaped segment emitting light is switched to 42C (only “VENT”), 42D (only “FLOOR”), 42B (only “DEF”), the combination of 42B and 42D (“DEF” and “FLOOR”), and the combination of 42C and 42D (“VENT” and “FLOOR”), respectively.

When the rotation angle detected by the rotary encoder 18 does not vary for two seconds, the controller 60 determines that the manipulation of setting the vent is finished, and calculates the instruction value for the car air-conditioner 100 from the difference between the rotation angle detected by the rotary encoder 18 at the time of starting the vent setting manipulation and the rotation angle detected by the rotary encoder 18 at the time of finishing the vent setting manipulation. Then, the instruction signal corresponding to the calculated instruction value is output to the car air-conditioner 100 through the communication driver 68.

When the output of the instruction signal through the communication driver 68 is finished, the controller 60 performs the operation of switching to the temperature setting mode, and thus the manipulation device 1 is restored to the temperature setting mode.

In the vent setting mode, the color and brightness of the backlight do not vary. The motor 8 is used only for generating the click touch and the rotation of the manipulation section 6 is not suppressed.

<3> Advantages of the Present Embodiment

According to the present embodiment, the following advantages can be obtained.

In the present embodiment, the coupled body 16 is supported to be tiltable only in the horizontal direction (the left-right direction in FIG. 1) by the support means, that is, the tilt axes 19 formed in the coupled body 16 and the tongues 20 formed in the rear case. Accordingly, the coupled body 16 is not tilted in the vertical direction due to the force of inertia of the motor 8 when a vertical impact is applied to the vehicle body. As a result, when the vertical impact is applied to the vehicle body, the vertical tilt manipulation of the manipulation section 6 not intended by an operator is not performed.

In the present embodiment, the laterally-long recessed portion 3B formed in the front case 3 and the left arrow 3C and the right arrow 3D formed with paint on the bottom surface of the recessed portion 3B are provided as the designed portion indicating the tiltable direction of the manipulation section 6. Accordingly, it can be indicated that the manipulation section 6 can be tilted only in the horizontal direction (the left-right direction in FIG. 1). As a result, it is possible to suppress an operator from tilting the manipulation section 6 in the vertical direction.

In the present embodiment, since the front profiles of the window portion 3E and the recessed portion 3B formed in the front case 3 are approximately similar to each other, it can be seen that the selection of display items and the tilt manipulation of the manipulation section 6 are associated with each other. As a result, an operator can understand by intuition that the selection of the display items can be performed by the tilt manipulation of the manipulation section 6.

In the present embodiment, since the surface (display plane) of the LCD 31 and the frame portion 3G form a recessed portion and the manipulation section 6 is formed as the recessed portion 3B in the front case 3, that is, since both of the surface (display plane) of the LCD 31 and the manipulation section 6 form a recessed portion, it can be seen more surely that the selection of the display items and the manipulation of the manipulation section 6 are associated with each other. As a result, an operator can more surely understand by intuition that the selection of the display items can be performed by the tilt manipulation of the manipulation section 6.

In the present embodiment, the groove 3F connecting the window portion 3E and the recessed portion 3B to each other is formed in the front case 3. As a result, a hint can be given that the LCD 31 can be manipulated with the manipulation section 6.

In the present embodiment, the shape of the ring-shaped segments 43 to 45 indicating the selected one of three setting items such as air flow, temperature, and vent and the front shape of the manipulation section 6 are similar to each other, that is, circular. Accordingly, a hint can be given that any one of three setting items can be selected by means of the tilt manipulation of the manipulation section 6.

In the present embodiment, viscous feeling can be generated in the manipulation section 6 to be rotated by grease (not shown) and the O ring 17 filled between the cylindrical portion 12A and the guide member 14 of the front engine cover 12.

In the present embodiment, as the designed portion indicating the tiltable direction of the manipulation section 6, the left arrow 3C and the right arrow 3D have been formed with paint on the bottom surface of the recessed portion 3B in the front case 3. However, the present invention is not limited to the embodiment, but the designed portion may be formed by protruding or recessing the bottom surface.

Although the shape of the ring-shaped segments 43 to 45 indicating the selected one of three setting items such as air flow, temperature, and vent and the front shape of the manipulation section 6 are similar to each other, that is, circular in the present embodiment, the present invention is not limited to the above-mentioned embodiment, but the front shape of the manipulation section 6 may be tetragonal, hexagonal, octagonal, etc. only if it is the same shape.

1. A haptic feedback input device comprising:
a manipulation section which is tilted and rotated;
a motor which is coupled to the manipulation section to deliver rotary power to the manipulation section and is tilted in response to a tilt manipulation of the manipulation section;
support means for tiltably supporting a coupled body of the manipulation section and the motor;
detection means for detecting the tilt of the coupled body; and
restoration means for restoring the coupled body to a neutral position from a tilted position,
wherein the support means mounts the coupled body to a vehicle such that a rotation axis of the manipulation section is approximately horizontal, and supports the coupled body to be tiltable only in an approximately horizontal direction.

2. The haptic feedback input device according to claim 1, further comprising a case which houses the motor and the coupled body such that the manipulation section is protruded,
wherein a designed portion indicating a tiltable direction of the manipulation section is formed on a surface of the case from which the manipulation section is protruded.

3. The haptic feedback input device according to claim 2, wherein the designed portion is formed around the manipulation section and includes a recessed portion extending in the tiltable direction of the manipulation section.

4. The haptic feedback input device according to claim 2, wherein the designed portion includes a mark indicating the tiltable direction of the manipulation section.
